(19) United States
(12) Patent Application Publication
(10) Pub. No.: US 2016/0262535 A1
(43) Pub. Date: Sep. 15, 2016

(54) KIT FOR ASSEMBLING FURNITURE, AND PIECE OF FURNITURE THUS OBTAINED

(71) Applicant: IBK PROJECT SRL, Pesaro (IT)

(72) Inventor: Massimo BERLONI, Pesaro (IT)

(73) Assignee: IBK PROJECT SRL, Pesaro (IT)

(21) Appl. No.: 15/033,172

(22) PCT Filed: Oct. 29, 2014
(86) PCT No.: PCT/EP2014/073177

§ 371 Date: Apr. 29, 2016

(30) Foreign Application Priority Data
Oct. 31, 2013 (IT) BO2013U000125

(51) Int. Cl. A47B 47/00; A47B 95/00; A47B 91/00; A47B 3/06; F16B 12/42; A47B 61/00; A47B 67/04; A47B 77/00; A47B 61/06; A47B 95/04; A47B 63/00

(52) U.S. Cl. CPC A47B 47/0041; A47B 95/04; A47B 95/00; A47B 91/00; A47B 95/008; A47B 3/06; A47B 63/00; A47B 61/00; A47B 67/04; A47B 77/00; A47B 47/0075; A47B 61/06; F16B 12/42

(57) ABSTRACT

A kit for assembling furniture comprising at least one panel, provided with two mutually opposite larger faces and four lateral surfaces; at least one strip having a substantially rectangular cross-section, which defines four flat perimetric faces, along at least one of which, having dimensions that are complementary to at least one respective lateral surface of the panel, there is at least one respective hole; at least one fixing element, of the type of a screw, a nail, a rivet, and the like, following the juxtaposition of the perimetric face provided with the hole against the lateral surface having complementary dimensions; the fixing element being insertable in the hole, through a corresponding inclined through seat, which faces the hole and is interposed between one of the larger faces and the lateral surface of the panel, for mutual stable coupling between the panel and the strip.

The present invention relates to a kit for assembling furniture and to the piece of furniture thus obtained.

As is known, in the field of interior decoration it is common to use furniture composed of one or more units having a boxlike shape, each of which has four panels that are coupled in pairs along perpendicular planes, so as to define a sort of parallelepipedal frame, which is closed at the rear by an additional back panel and, if necessary, also at the front, by means of doors, sliding walls, or other similar elements.

Furniture of the type indicated above is in fact the foundation of interior decoration solutions of different types, such as desks, bookshelves, wardrobes, chests of drawers, trunks, etc., in addition to often accommodating electrical household appliances such as ovens, dishwashers, washing machines and the like, for example in modular kitchens.

In this context, since it is necessary to meet the requirements of customers who are increasingly demanding and competent but however cost-conscious, manufacturers are constantly seeking solutions capable of ensuring the necessary strength and reliability over time with low costs.

Moreover, there is an ever growing offer of modular solutions, which offer maximum versatility and the possibility to adapt to the specific requirements (and to the available spaces) of each individual buyer. Especially for such furniture, another parameter capable of constituting an important competitive advantage is ease of assembly, which is of course welcomed by professional installation technicians but is absolutely crucial when, as occurs increasingly often, the assembly of the finished product is entrusted to the buyer himself.

It is therefore evident that the needs to reconcile different requirements and needs, that are often in contrast with each other, make it difficult to design winning interior decoration solutions and in general poses problems that are not easy to solve to manufacturers.

The aim of the present invention is to solve the problems described above, by providing a kit that ensures easy and practical assembly of furniture or parts thereof.

Within this aim, an object of the invention is to provide a piece of furniture that can be assembled in a practical and easy manner.

Another object of the invention is to provide a kit that ensures high strength and reliability at low costs.

A further object of the invention is to provide a piece of furniture composed of elements obtained by means of simple and low-cost processes.

A further object of the invention is to provide a kit that can be obtained easily starting from commonly commercially available elements and materials.

Another object of the invention is to provide a kit that is safe in application.

This aim and these and other objects are achieved by a kit for assembling furniture, characterized in that it comprises at least one panel, provided with two mutually opposite larger faces and four lateral surfaces; at least one strip having a substantially rectangular cross-section, which defines four flat perimetric faces, along at least one of said perimetric faces, which has dimensions that are complementary to at least one respective said lateral surface of said panel, there being at least one respective hole; at least one fixing element, of the type of a screw, a nail, a rivet, and the like, following the juxtaposition of said at least one perimetric face provided with said hole against said at least one lateral surface having complementary dimensions, said fixing element being insertable in said hole, through a corresponding inclined through seat, which faces said at least one hole and is interposed between one of said larger faces and said at least one lateral surface of said panel, for mutual stable coupling between said at least one panel and said at least one strip.

This aim and these objects are also achieved by a piece of furniture, characterized in that it comprises at least one panel, provided with two mutually opposite larger faces and four lateral surfaces; at least one strip having a substantially rectangular cross-section, which defines four flat perimetric faces, at least one of said perimetric faces being juxtaposed against a respective lateral surface, having complementary dimensions, of said at least one panel and having at least one respective hole; at least one fixing element, such as a screw, a nail, a rivet, and the like, inserted in said hole through a corresponding inclined through seat, which faces said at least one hole and is interposed between one of said larger faces and said at least one lateral surface having complementary dimensions, for mutual stable coupling between said at least one panel and said at least one strip.

Further characteristics and advantages of the invention will become better apparent from the description of a preferred but not exclusive embodiment of the kit according to the invention, illustrated by way of nonlimiting example in the accompanying drawings, wherein:

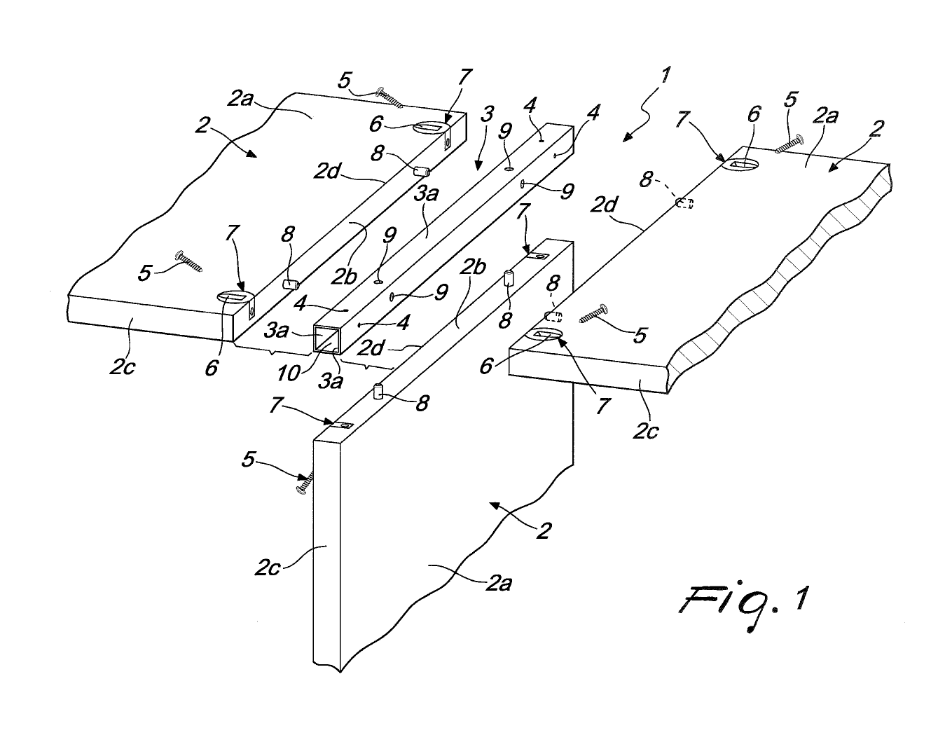

FIG. 1 is an at least partially exploded perspective view of the kit according to the invention;

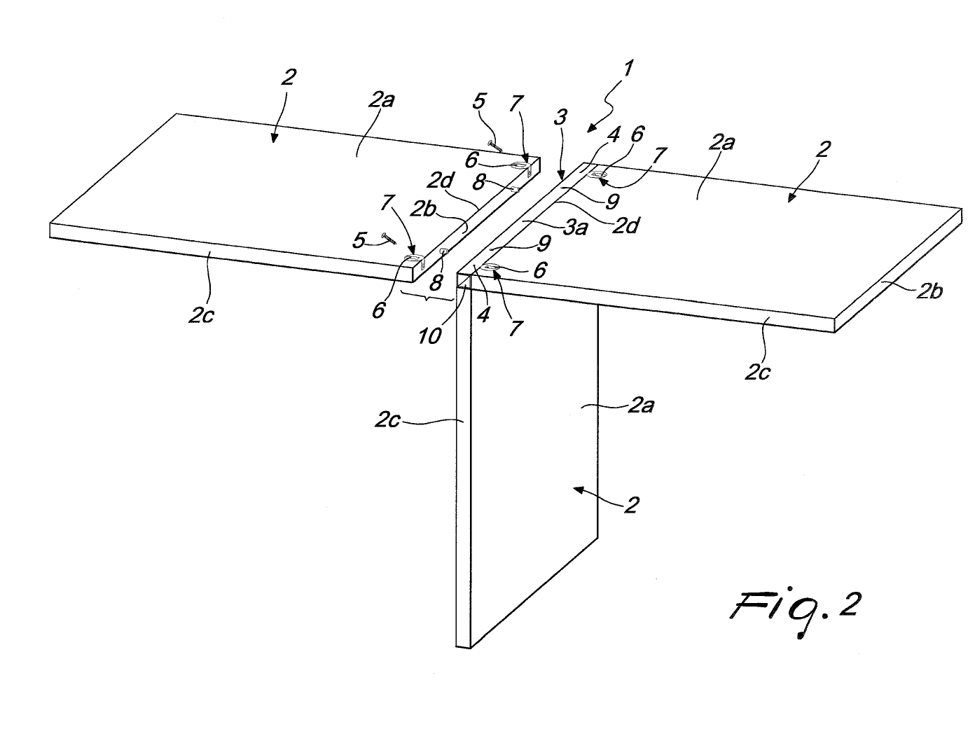

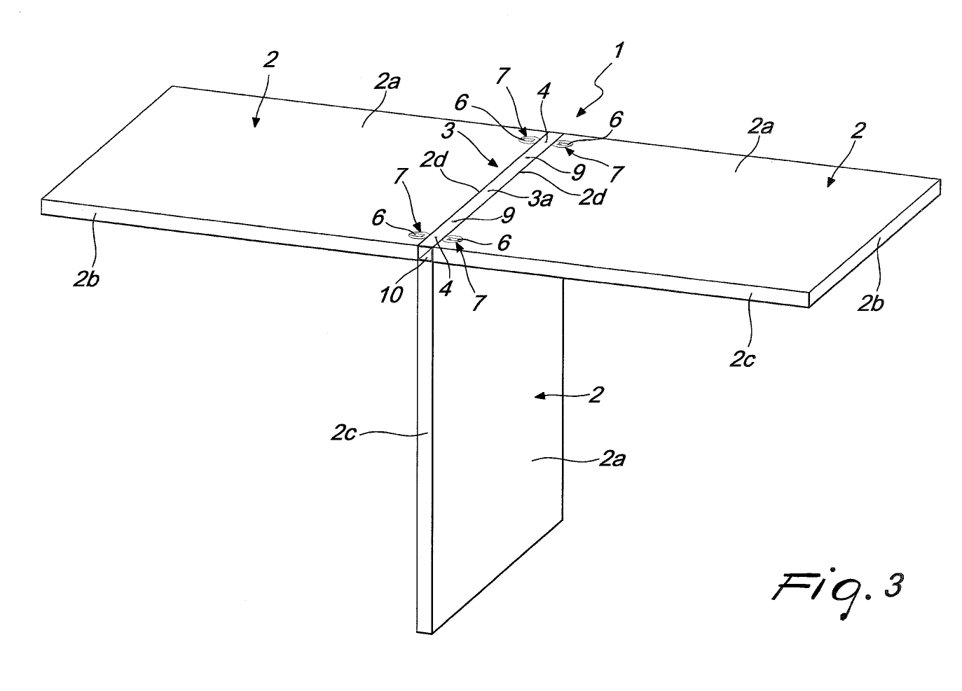

FIGS. 2 and 3 are perspective views of a possible use of the kit according to the invention, for mutual coupling between three panels and a strip;

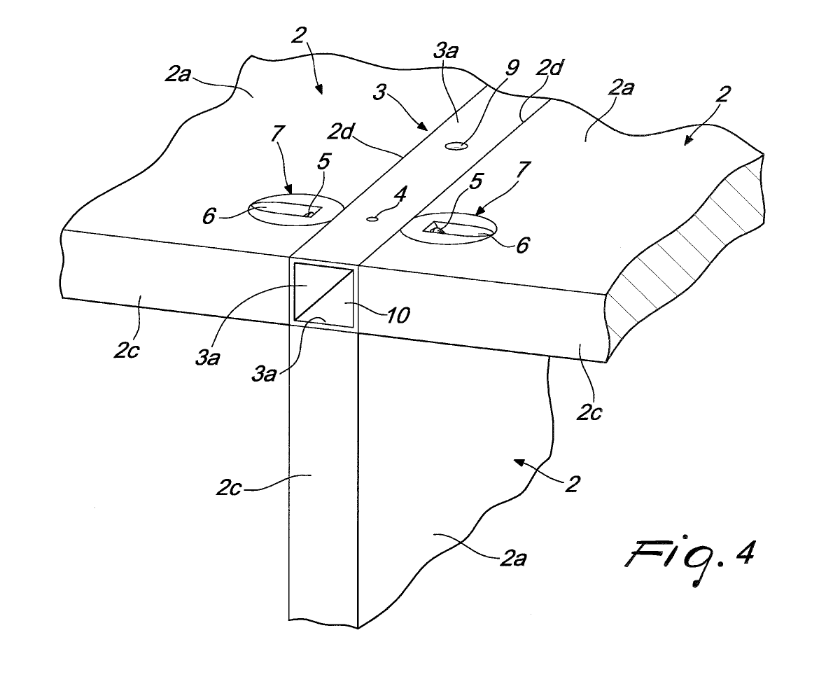

FIG. 4 is a highly enlarged-scale view of a detail of FIG. 3.

With particular reference to the cited figures, the reference numeral 1 generally designates a kit that can be used to assemble pieces of furniture (or in any case parts thereof).

According to the invention, the kit 1 comprises first of all at least one panel 2, which has two mutually opposite larger faces 2a and four lateral surfaces 2b, 2c (also of course mutually opposite in pairs): as can be seen clearly from the accompanying figures, the panel 2 has in practice a flattened substantially parallelepiped shape and is made of a material at will (a polymeric material, a metallic material, wood, etc.) and can constitute a base unit for the provision of furniture of various types.

Moreover, the kit 1 according to the invention comprises at least one strip 3 having a substantially rectangular cross-section, which defines four flat perimetric faces 3a: along at least one of said perimetric faces 3a, which has dimensions that are complementary to at least one respective lateral surface 2b of the panel 2, there is at least one respective hole 4, the function of which will become better apparent in the paragraphs that follow.

The strip 3 also can be made of a material at will, without abandoning the protective scope claimed herein; for example, mention is made of the possibility that it can be made of aluminum or of another metallic material.

Moreover, the kit 1 according to the invention comprises at least one fixing element, of the type of a screw 5, a nail, a rivet, and the like; more particularly, in the preferred (not exclusive) constructive embodiment, said fixing elements are selected of the type of self-tapping screws 5. In any case, when the perimetric face 3a provided with the hole 4 is juxtaposed against the respective lateral surface 2b having complementary dimensions, such fixing element can be inserted in the hole 4 (as can be seen from the accompanying figures) through a corresponding inclined through seat 6, which indeed makes the hole 4 accessible through the panel 2.

The inclined seat 6 in fact faces the hole 4 and is interposed between one of the larger faces 2a and the respective lateral surface 2b of the panel 2, in order to allow mutual stable coupling between the panel 2 and the strip 3.

It should be noted already that the inclined seat 6, required to ensure the coupling between the panel 2 and the strip 3 after the latter has been juxtaposed against the former in the final configuration that one wishes them to assume, can be provided directly in the panel 2, or obtained in various manners, without abandoning the protective scope claimed herein.

In a constructive solution of considerable practical interest, which is proposed in the accompanying figures by way of nonlimiting example of the application of the invention, the kit 1 according to the invention also comprises at least one insert 7, which can be accommodated rigidly in at least one recess, provided substantially at at least one predefined edge 2d of the panel 2, and the insert 7 indeed defines inside it the inclined seat 6. Conveniently, in the preferred constructive solution, which does not limit the application of the invention, the kit 1 comprises a plurality of panels 2 and/or strips 3 (each of which has respective holes 4 on each perimetric face 3a) and/or fixing elements and/or inserts 7.

Thus, the user can provide the stable coupling according to a plurality of different possible configurations and thus achieve the assembly of furniture (composed indeed of a plurality of panels 2) of different types.

The accompanying figures show merely by way of example that indeed it is possible to couple mutually in a T-shaped configuration three panels 2 by means of the interposition of a single strip 3 (which is provided with holes 4 on all of its perimetric faces 3a, in order to accommodate the screws 5 inserted in the seats 6 of each one of the three panels 2 to be coupled).

Likewise, by means of just two panels 2 and one strip 3 it is possible to provide easily an L-shaped coupling (by acting on two adjacent perimetric faces 3a of the strip 3) or also to arrange and mutually couple two panels 2 in a coplanar manner (affecting two mutually opposite perimetric faces 3a), as a function of the specific requirements.

More generally, therefore, it is already evident that by means of the kit 1 it is possible to assemble furniture composed of one or more units having a box-like shape, each of which has four panels 2 that are coupled in pairs along perpendicular planes, so as to define a sort of parallelepipedal frame; moreover, the multiple configurations that can be obtained in a fully intuitive manner by mutually combining two or more panels 2, by means of the strips 3, allow to provide shelves, shelf units, tables, and interior decoration solutions of various different shapes, without abandoning the protective scope claimed herein.

In order to ensure maximum versatility and modularity, and therefore the possibility of assembly according to the largest number of different possible configurations, in the preferred but not exclusive constructive solution each strip 3 has a square cross-section (as indeed in the accompanying figures) and each perimetric face 3a has a shape that is complementary to two respective mutually opposite lateral surfaces 2b of each panel 2.

Moreover, with further reference to such preferred constructive solution, each strip 3 is provided with two holes 4, which are aligned longitudinally and are arranged so as to face each other and be proximate to two respective inclined seats 6 of a respective panel 2 when the respective perimetric face 3a of the strip 3 is juxtaposed against the corresponding lateral surface 2b of the panel 2.

Obviously, it is possible to provide a kit 1 according to the invention with an even larger number of holes 4 if the specific requirements of application make this preferable (and for example to ensure maximum stability of the coupling to be provided as a function of the overall dimensions of the components involved).

Conveniently, the kit 1 according to the invention comprises at least one dowel 8, which on opposite sides can be inserted in respective orifices 9 provided on each one of the perimetric faces 3a of the strips 3 and on the lateral surfaces 2b, having complementary dimensions, of the panels 2. The orifices 9 in fact can be mutually aligned at the juxtaposition of a perimetric face 3a with the respective lateral surface 2b, and this allows, as will become better apparent hereinafter, a more practical coupling between a panel 2 and a strip 3 and furthermore ensures an increase in the resistance to stresses of the assembly (of the piece of furniture) thus obtained.

Advantageously, each strip 3 has an axial duct 10, which preferably has a square cross-section and is open outwardly, so as to allow the insertion, at at least one of end of one or more strips 3, of accessories of various types, of the type for example of decorative plugs, covering studs, floor resting feet, hangers, and the like.

The axial ducts 10 can be dead or, as shown in the accompanying figures, be extended along the entire length of the respective strip 3.

More particularly, such accessories of various types can be provided by the user separately or the kit 1 according to the invention can comprise directly a plurality thereof, selected preferably indeed of the type of decorative plugs, covering studs, floor resting feet, hangers, and the like, which in any case can be inserted in the coaxial ducts 10 at at least one of the ends of the strips 3.

Moreover, it is not excluded to associate with the strips 3 accessories of various types also through the orifices 9 if some of them are not used to accommodate dowels 8.

The present description also relates to a piece of furniture which, according to the invention, comprises at least one panel 2, which has two mutually opposite larger faces 2a and four lateral surfaces 2b, 2c. Furthermore, the piece of furniture according to the invention comprises at least one strip 3 having a substantially rectangular cross-section, which thus defines four flat perimetric faces 3a, at least one of which is juxtaposed against a respective lateral surface 2b, having complementary dimensions, of the panel 2 and has at least one respective hole 4. Finally, the piece of furniture according to the invention comprises at least one fixing element, of the type of a screw 5, a nail, a rivet, and the like, which is inserted in the hole 4 through a corresponding inclined through seat 6, which faces the hole 4 and is interposed between a larger face 2a and the lateral surface 2b having complementary dimensions, for the stable mutual coupling between the panel 2 and the strip 3.

The use of the kit (and of the piece of furniture) according to the invention is as follows.

The kit 1 can be used effectively to assemble and obtain pieces of furniture of various types, which in any case have laminar elements, of the type of panels 2, to be mutually coupled (at right angles or in a coplanar arrangement) or to be associated with additional components by using strips 3.

As shown, in fact, this type of furniture is widespread and constitutes or is the foundation for various interior decoration solutions, such as chests of drawers, wardrobes, shelves, tables, trunks, shelf units, etc.

By means of the kit 1 according to the invention, therefore, the user (or in any case the installation technician) can juxtapose a strip 3 against a panel 2, so that a perimetric face 3a of the former rests against a lateral surface 2b of the latter, which has, as shown, dimensions that are complementary to the perimetric face 3a.

Thanks to the presence of the inclined seats 6, defined in the inserts 7 that can be accommodated in the recesses provided along one or more edges 2d of the panel 2, the holes 4 provided along the perimetric face 3a, which otherwise are hidden from the user and are not accessible, can be affected by the screws 5.

Therefore, without additional components and/or cantilever connections, it is thus possible to couple each panel 2 to a respective strip 3 and, by utilizing the various perimetric faces 3a of the latter, each provided with respective holes 4, obtain a stable coupling and then, if needed, provide in a practical and easy manner more complex structures (T-shaped, L-shaped, etc.) that involve two or more panels 2.

During the assembly operations, the juxtaposition of each strip 3 against a respective panel 2 can be facilitated by resorting to the dowels 8: in fact, by inserting them in the desired panel 2 (as can be seen for example in FIG. 1) it is possible to rest on the latter the respective strip 3, providing its correct positioning and a temporary pre-coupling, before the insertion of the screw 5 in the seat 6 mutually fastens the panel 2 and the strip 3.

Moreover, the dowels 8 give greater strength to the resulting assembly, ensuring a higher capacity to withstand the stresses that the piece of furniture will have to bear.

Finally, it should be noted that the components of the kit 1 according to the invention (the panels 2, the strips 3, etc.) have shapes that can be obtained easily by means of processes that are simple and low-cost, ensuring the greatest economy of the kit 1 (and of the piece of furniture) according to the invention.

Moreover, while ensuring the possibility to provide various types of furniture (of various shapes and dimensions), it should be noted that the kit 1 according to the invention has an extremely small number of different components, and this contributes further to the containment of overall costs without compromising its maximum versatility and modularity.

In practice it has been found that the kit and the piece of furniture according to the invention achieve fully the intended aim and objects, since resorting to at least one panel, to at least one strip, having at least one of its perimetric faces with dimensions that are complementary to at least one respective lateral surface of the panel, and to at least one fixing element, which can be inserted in a hole provided along said perimetric face through a corresponding inclined through seat interposed between one of the larger faces of the panel and said lateral surface, ensures mutual stable coupling between the panel and the strip and therefore allows easy and practical assembly of pieces of furniture or of parts thereof.

The invention thus conceived is susceptible of numerous modifications and variations, all of which are within the scope of the appended claims; all the details may further be replaced with other technically equivalent elements.

In the exemplary embodiments shown, individual characteristics, given in relation to specific examples, may actually be interchanged with other different characteristics that exist in other exemplary embodiments.

In practice, the materials used, as well as the dimensions, may be any according to requirements and to the state of the art.

The disclosures in Italian Utility Model Application No. BO2013U000125 from which this application claims priority are incorporated herein by reference.

1-10. (canceled)

11. A kit for assembling furniture, comprising:
at least one panel, provided with two mutually opposite larger faces and four lateral surfaces;
at least one strip having a substantially rectangular cross-section, which defines four flat perimetric faces, along at least one of said perimetric faces, which has dimensions that are complementary to at least one respective said lateral surface of said panel, there being at least one respective hole;
at least one fixing element, of the type of a screw, a nail, a rivet, and the like, following the juxtaposition of said at least one perimetric face provided with said hole against said at least one lateral surface having complementary dimensions, said fixing element being insertable in said hole, through a corresponding inclined through seat, which faces said at least one hole and is interposed between one of said larger faces and said at least one lateral surface of said panel, for mutual stable coupling between said at least one panel and said at least one strip.

12. The kit according to claim 11, further comprising at least one insert, which can be accommodated rigidly in at least one recess, provided substantially at at least one predefined edge of said at least one panel, said at least one insert defining internally said inclined seat.

13. The kit according to claim 12, further comprising a plurality of said panels and/or of said strips, provided with respective said holes on each one of said perimetric faces, and/or of said fixing elements and/or of said inserts, for mutual stable coupling according to a plurality of different possible configurations and for the assembly of furniture of different types.

14. The kit according to claim 13, wherein each one of said strips has a square cross-section, each one of said perimetric faces having a shape that is complementary to two respective mutually opposite lateral surfaces of each one of said panels.

15. The kit according to claim 13, wherein each one of said strips has two of said holes, which are aligned longitudinally and are arranged so as to face each other and proximate to two respective said inclined seats of a respective said panel, at the juxtaposition of the respective said perimetric face against said lateral surface.

16. The kit according to claim 13, further comprising at least one dowel, which can be inserted in respective orifices provided on each one of said perimetric faces of said strips and on said lateral surfaces, which have complementary dimensions, of said panels, which can be mutually aligned at the juxtaposition of one said perimetric face against the respective said lateral surface, for a more practical mutual coupling of one of said panels and of one of said strips and the increase of resistance to stresses.

17. The kit according to claim 11, wherein each one of said strips has a coaxial duct, which has a square cross-section and is open outwardly, for insertion, at at least one end of said strips, of accessories of various types, such as decorative plugs, covering studs, floor resting feet, hangers, and the like.

18. The kit according to claim 17, further comprising a plurality of said accessories of various types, selected preferably of the type of decorative plugs, covering studs, floor resting feet, hangers, and the like, which can be inserted in said coaxial ducts, at at least one of said ends of said strips.

19. The kit according to claim 11, wherein each one of said fixing elements is constituted by self-tapping screws.

20. A piece of furniture, comprising:
at least one panel, which has two mutually opposite larger faces and four lateral surfaces;
at least one strip having a substantially rectangular cross-section, which defines four flat perimetric faces, at least one of said perimetric faces being juxtaposed against a respective lateral surface, having complementary dimensions, of said at least one panel and having at least one respective hole;
at least one fixing element, of the type of a screw, a nail, a rivet, and the like, inserted in said hole through a corresponding inclined through seat, which faces said at least one hole and is interposed between one of said larger faces and said at least one lateral surface having complementary dimensions, for stable mutual coupling between said at least one panel and said at least one strip.
